(19) United States
(12) Patent Application Publication
(10) Pub. No.: US 2007/0284157 A1
(43) Pub. Date: Dec. 13, 2007

(54) Drive train for a motor vehicle comprising an electric machine

(76) Inventors: Marcus Heller, Farmington Hills, MI (US); Jens Renneberg, Berlin (DE); Sven Rolle, Berlin (DE); Wolfgang Schwienbacher, Dettingen (DE); Yehia Tadros, Berlin (DE)

Correspondence Address: KLAUS J. BACH, 4407 TWIN OAKS DRIVE, MURRYSVILLE, PA, 15668, US

(21) Appl. No.: 11/784,203

(22) Filed: Apr. 5, 2007

Related U.S. Application Data
(63) Continuation-in-part of application No. PCT/EP05/10615, filed on Oct. 1, 2005.

(30) Foreign Application Priority Data
Oct. 6, 2004 (DE) 10 2004 048 908.4

(51) Int. Cl. B60K 8/00

(52) U.S. Cl. 180/54.1

(57) ABSTRACT

In a drive train for a motor vehicle, with a converter bell arranged between an internal combustion engine and a transmission, and a drive shaft extending through the converter bell and carrying a clutch device and an electric machine together with a power converter, which comprises at least one capacitor and power electronics which are integrated into the converter bell, the capacitor and the power electronics are arranged between a stator of the electric machine and the converter bell such that they are distributed around the outer circumference of the electric machine in the radial direction and the capacitor and the power electronics are arranged such that they are in thermally conductive contact with the cooling system for the stator of the electric machine.

This is a Continuation-in-Part Application of pending International Patent Application PCT/EP2005/010615 filed Oct. 1, 2005 and claiming the priority of German Patent Application 10 2004 048 908.4 filed Oct. 6, 2004.

### BACKGROUND OF THE INVENTION

The invention relates to a drive train for a motor vehicle comprising an electric machine disposed between an internal combustion engine and a transmission and also to an electric machine for driving a motor vehicle, especially a so-called hybrid motor vehicle.

A drive train of this generic type is described by Y. Tadros et al. in “Ring Shaped Motor-Integrated Electric Drive for Hybrid Electric Vehicles”, 10th European Conference on Power Electronics and Applications; Toulouse, 2003. In that publication, an electric machine is integrated in a converter bell between the internal combustion engine and transmission next to a clutch. The electric machine of this type, which can be designed in accordance with DE 102 07 486 A1, has integrated power electronics which are cooled together with the stator of the electric machine.

However, connecting the power electronics to the stator or to the cooling system of said stator in the axial direction of the electric machine means said electric machine becomes relatively large in the axial direction and requires a great deal of installation space. The installation space requirement of such short and thick electric machines constitutes a real disadvantage in hybrid drives in particular.

DE 103 25 527 A1 describes the integration of the power electronics together with an intermediate-circuit capacitor into the electric machine, with different types of power electronics and capacitors being used depending on physical shape and physical size.

However, at least in the case of relatively small electric machines, the problem arises that the power electronics are typically designed to be flat and not rounded. As the size of the electric machine decreases, the contact area between the power electronics and stator and thus the cooling system also decreases and the heat transfer is detrimentally affected thereby.

In addition, the ring-like capacitor is likewise subjected to very severe thermal loads as the electric machine is heating up during operation. The capacitor is subjected to high stresses by thermal expansion, particularly in the direction of the circumference, at least when used in electric machines which are subjected to a high thermal load, for example electric machines of a drive train which have to provide highly dynamic power profiles and which are frequently switched on and off. Because of the stresses, very fine (micro)-cracks may be produced in the so-called spray-metallized layer on the capacitor, which layer serves to make electrical contact with said capacitor, as a result of which the capacitor becomes inoperable. Furthermore, the expansion of the capacitor, which typically manifests itself as an extension in the direction of the circumference of said capacitor, may adversely affect or completely destroy contact with the cooling system of the stator. The capacitor, which is therefore no longer cooled or only poorly cooled, consequently overheats quickly, which further impairs contact. This may ultimately lead to the capacitor breaking down since it will become too hot.

In the specific case of a motor vehicle drive train, the electric machine is typically cooled by means of the cooling circuit of the internal combustion engine. Therefore, passive cooling and heating of the electric machine by the cooling water, which is at different temperatures depending on the load state of the internal combustion engine, for thermally loading the power electronics and in particular the capacitor also plays a critical role with the disadvantages already mentioned above.

EP 1 418 660 A1 discloses an electric machine in which a unit comprising power electronics is associated with each winding of the stator. In this case, these units are distributed around the circumference of the stator on flat surfaces and are cooled together with said stator by cooling ducts. DE 101 12 799 C1 discloses a fluid-cooled electric machine of similar design, in which, for cooling the power electronics, cooling elements of the power electronics project into a duct which surrounds the stator.

The problem in that case is that an intermediate-circuit capacitor still has to be arranged outside the electric machine. However, the inductions which are inherent to the line elements for connection of said intermediate-circuit capacitor lead to considerable problems with voltage peaks which can very easily damage the components of the power electronics, and particularly the semiconductor switching elements in this case.

It is the object of the present invention to avoid the described disadvantages and provide a very compact electric machine for independent use or for integration into a drive train, which electric machine also can be reliably operated under high alternating thermal loads.

### SUMMARY OF THE INVENTION

In a drive train for a motor vehicle, with a converter bell arranged between an internal combustion engine and a transmission, and a drive shaft extending through the converter bell and carrying a clutch device and an electric machine together with a power converter, which comprises at least one capacitor and power electronics which are integrated into the converter bell, the capacitor and the power electronics are arranged between a stator of the electric machine and the converter bell such that they are distributed around the outer circumference of the electric machine in the radial direction and the capacitor and the power electronics are arranged such that they are in thermally conductive contact with the cooling system for the stator of the electric machine.

Integration both of the electric machine into the converter bell and of the power electronics and the capacitor into the electric machine forms a very compact electric drive module in the drive train. For this purpose, firstly common cooling of the stator, capacitor and power electronics is an important feature in the establishment of such a compact electric machine. Secondly, the arrangement of the power electronics and the capacitor in the radial direction around the stator or the cooling system of the stator primarily plays a critical role since, in this way, is it possible to provide an electric machine which is sufficiently compact to be accommodated in the space available, particularly in an axial direction.

Excess heat can be very easily and efficiently dissipated by virtue of a common cooling of the stator, capacitor and power electronics, as a result of which thermal stress for the integrated assembly comprising the stator, capacitor and power electronics are largely avoided. Furthermore, expenditure on modification of the cooling circuit of the vehicle is minimized since it is only necessary to cool a single further component, namely the integrated assembly comprising the stator, capacitor and power electronics.

The drive train according to the invention therefore allows supplemental driving of a vehicle by an electric machine, without important parts of the conventional drive train having to be changed for this purpose. It is therefore possible to produce a hybrid drive concept for a motor vehicle with an electric machine which can be used as a motor and generator in a very simple and efficient manner, without the shape or size of the conventional drive train having to be changed. The drive train according to the invention can therefore be easily integrated in conventional vehicles without the need for structural changes to the drive train or its support etc.

According to a further advantageous development of the drive train according to the invention, the drive train is designed in such a way that the capacitor and the power electronics together with the electronics for actuating the power electronics are formed one on top of the other in least two layers, with the layers having different dimensions and/or being offset in relation to one another in the axial direction of the electric machine.

The installation space available in the converter bell can be utilized very effectively by virtue of arranging the capacitor and the power electronics and the control electronics for actuating the power electronics one above the other in the at least two layers. In this case, the individual layers can have different dimensions in the axial direction of the electric machine and can therefore be easily matched to the curved shape of the converter bell which usually has a trapezoidal cross section. The layered design also means that the power electronics which have to be cooled can be arranged in the layer which faces the stator, whereas the curved, uncooled installation space situated thereabove can be used for control electronics for actuating the power electronics, which are not critical in terms of cooling.

The invention also resides in an electric machine wherein the power electronics of the power converter are arranged such that they are distributed around the outer circumference of the electric machine in the radial direction, and the capacitor extends around the outer circumference of the electric machine with the capacitor having a plurality of at least partial interruptions distributed around the circumference of the capacitor.

An electric machine which is very compact, particularly in terms of its axial expansion, can be produced with such a design. In addition, extremely short runs of the electrical lines, particularly between the capacitor and the power electronics, can be realized. The inductances which are inherent to the lines are therefore minimized. The power-electronics components are therefore generally not subjected to voltage peaks which may occur during operation.

The at least partial interruptions in the circumference of the capacitor which extends around the circumference of the electric machine ensure that said capacitor operates safely and reliably despite the unavoidable thermal stresses. The capacitor which is arranged around the circumference of the electric machine is inevitably heated up during operation. This continually produces thermally induced changes in expansion of said capacitor in spite of active cooling. Integration of the capacitor around the circumference of the electric machine or the stator of said electric machine produces considerable thermally induced changes in length, primarily in the direction of the circumference of the capacitor which may, in particular, be in the form of a ring. These changes in length lead to severe material stresses, particularly in the metal materials, for example of the spray-metalized layer of the capacitor, since they have only a comparably low elasticity, like the polymer films of a film capacitor for example. In this case, (micro)cracks which are produced in the metal layers could make the capacitor unusable. However, these problems are now avoided with the design according to the invention by the capacitor having a plurality of at least partial interruptions distributed around its circumference. Said interruptions serve as “expansion joints” which help to prevent the capacitor from being adversely affected by the thermal expansion.

The abovementioned disadvantages in terms of thermal stresses in the capacitor are avoided in an ideal manner by breaking up the whole capacitor into a plurality of sub-elements. The capacitor, which may be wound as a single film or foil capacitor in a particularly advantageous manner and then cut, comprises only comparatively short spaced sections, with the result that the thermally induced changes in length do not lead to any fault.

In this case, a busbar arrangement makes contact with the individual sections of the capacitor.

In a preferred development of the invention, the busbar arrangement can in this case have length-compensation elements of different configurations.

The bus bar arrangement can in this way also be protected against damage from thermal expansions. The arrangement of the length-compensation elements in the region of the interruptions provides for an assembly whose length is sufficiently flexible and which is very compact.

In an alternative refinement of the invention, not the entire capacitor is sectionalized, but rather only its sprayed-on metallized layer. In this case, a spray-metallized layer in capacitors is understood to be the layer which forms the respective electrical terminal. In the case of wound foil capacitors, the respective end faces of the foils are, for example, connected to one another on each of the sides by spraying on liquid metal. After hardening, this sprayed-on metal then forms the respective contact area, the so-called spray-metallized layer. These spray-on metallized layers which are formed on the axial side surfaces of the capacitor are distributed around the circumference of the capacitor and in each case completely interrupted a number of times. This also produces expansion joints which, in a manner comparable to that already illustrated above, prevent thermal-expansion-induced (micro)-cracks in the spray-metallized layer and therefore prevent the capacitor being mechanically damaged by the stresses.

Preferably, the capacitor is held on the stator under tension by a tensioning belt which extends around the capacitor and continuously presses the capacitor or the sub-elements of the capacitor against the stator or the cooling system of the stator. If the pre-stress is selected to be sufficiently high, reliable contact between the capacitor and the stator or the cooling system of the stator can continue to be provided given corresponding heating and expansion of the capacitor. Permanent cooling of the capacitor under all circumstances of operation is therefore ensured.

A polygonal region is preferably provided next to the capacitor, which itself is likewise polygonal, preferably in the form of a ring, and which enables the components of the power electronics to be fitted on flat surfaces. Therefore, contact can be made with the stator or the cooling system of the stator over a large area, and effective cooling of said stator can therefore be ensured. A further advantage of the polygonal region is that a modular design with identical modules of the power electronics can be achieved. Adapting to the size and/or power of the electric machine is then carried out solely by selecting the number of sections, for example hexagonal, octagonal or dodecagonal. The same modules of the power electronics can then in each case be installed on the flat surfaces of the individual sections or of at least some of the sections independently of the size of the electric machine. As in every other type of modular construction, advantages in terms of flexibility are also produced here. Furthermore, identical modules can be used for electric machines of different sizes, which in turn reduces the costs of such a module as larger quantities of identical modules are produced.

The invention will become more readily apparent from the following description of exemplary embodiments with reference to the accompanying drawings:

### BRIEF DESCRIPTION OF THE DRAWINGS

FIG. 1 shows a drive train comprising an internal combustion engine, with an electric machine disposed in a converter bell and with a transmission;

FIG. 2 shows a possible circuit arrangement of the power electronics and a capacitor for the electric machine;

FIG. 3 shows a further possible circuit arrangement of the power electronics and a capacitor;

FIG. 4 shows a possible arrangement of a capacitor around the electric machine;

FIG. 5 shows, in a schematic illustration, a possible design of the capacitor;

FIG. 6 shows an embodiment providing for interruptions in a spray-metallized layer of the capacitor;

FIG. 7 shows an alternative embodiment of the interruptions in a spray-metallized layer of the capacitor;

FIG. 8 shows a possible embodiment for the spaced arrangement of the capacitor segments;

FIG. 9 shows a possible embodiment of a current-conducting busbar arrangement with length-compensation elements;

FIG. 10 shows a possible design of an arrangement of the power electronics and capacitor around an electric machine;

FIG. 11 shows a possible arrangement of power-electronics modules around a relatively small electric machine;

FIG. 12 shows a possible arrangement of power-electronics modules around a relatively large electric machine using the same modules used in a smaller machine; and

FIG. 13 shows, in an axial sectional illustration, a possible arrangement of the power electronics and of the capacitor around the electric machine.

### DESCRIPTION OF VARIOUS EMBODIMENTS

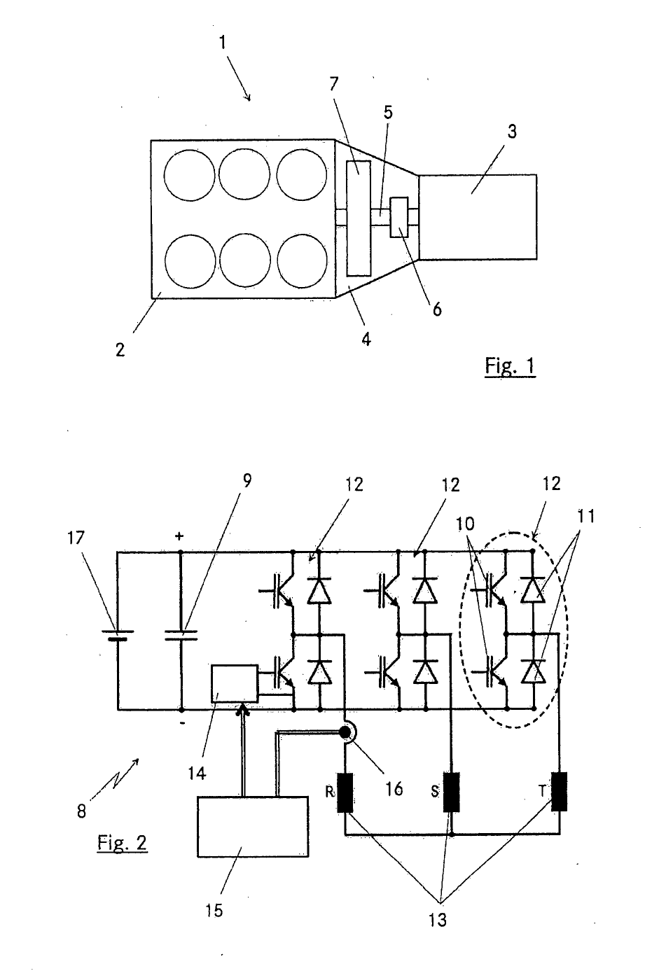

FIG. 1 shows a schematic plan view of a detail of a drive train 1. The main part of said drive train comprises an internal combustion engine 2 and a transmission 3. A converter bell 4, in which a drive shaft 5 for driving the transmission 3 using the internal combustion engine 2 extends, is arranged between the internal combustion engine and the transmission. As is generally customary, a clutch device 6 for interrupting the connection between the internal combustion engine 2 and the transmission 3 is also arranged in the converter bell 4. In addition, an electric machine 7 is arranged in the converter bell 4. In its drive mode, the electric machine can be used to drive the vehicle, which is provided with the drive train 1. In a generator mode, for example when the vehicle is decelerating, the electric machine 7 can generate electrical energy and feed it back to a suitable storage device, for example a battery and/or a high-power capacitor (supercap). A drive train 1 of this type is typically used in a hybrid motor vehicle. However, the electric machine itself would also be suitable for other purposes, for example for driving a fuel-cell vehicle.

As is known from the prior art, so-called integrated drives, that is to say those drives in which the power converter or inverter required to operate the electric machine 7 are integrated in the electric machine, are tried out for reasons of space and cost.

FIG. 2 shows a circuit diagram of a power converter 8 of this type. The power converter substantially comprises the power electronics and a capacitor 9, the so-called intermediate-circuit capacitor. The core of the power electronics in turn comprises semiconductor switches 10 and diodes 11. In this case, said power electronics comprise a plurality of so-called bridge legs 12 which each activate one of the motor windings 13 in the circuit arrangement of FIG. 2. In this case, the switches 10 of the power electronics are each actuated by means of the so-called gate drive units GDU 14, of which only one is illustrated here by way of example. Together with a controller 15, these GDUs 14 thus form the electronics for actuating the power electronics, with a sensor 16 also being shown here which supplies the controller with responses from the region of the electric machine 7 and the motor windings 13. In this case, this assembly is connected between the electric machine 7 and an electrical power source 17 for said electric machine. The power source 17 can, for example, be a battery and/or a high-power capacitor and/or a fuel cell.

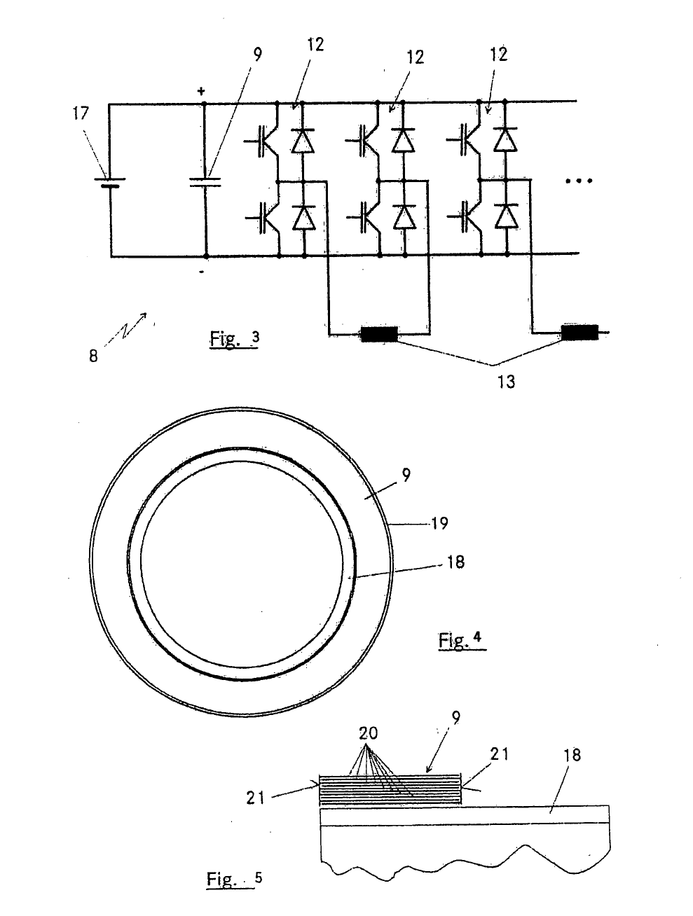

FIG. 3 shows a comparable assembly. This assembly can, for example, be used to actuate higher-power electric machines 7. In this case, each of the motor windings 13 is actuated by two or more bridge legs 12, in order to be able to deal with the correspondingly higher powers to be switched.

The entire power converter 8 is integrated in the electric machine 7, independently of its electrical circuit arrangement, as explained above. This provides considerable advantages in terms of space requirement, costs, cabling and electromagnetic compatibility (EMC).

The restrictive space conditions mean some components of unconventional shape are required. In order to then integrate the capacitor 9 in the electric machine 7 in as compact a manner as possible, said capacitor may be designed as, for example, a ring-shaped capacitor 9, as illustrated in FIG. 4. The capacitor 9 has to be cooled in order to allow a high current-carrying capacity. It is therefore mounted in a circular manner on the outer circumference of a cooled support 18 whose inner face is provided with the motor windings 13 (not illustrated here) of the stator of the electric machine 7. The cooled support 18 constitutes both the cooling system for the capacitor 9 and also the cooling system for the stator. However, the support 18 exhibits a different thermal expansion behavior to the capacitor 9 in this case. In order to then always keep the capacitor in direct contact with the support 18 and therefore to ensure it is sufficiently cooled, said capacitor is pre-stressed on the support 18 around its outer circumference by a tensioning belt 19. In this case, the pretension is selected to be high enough for the capacitor 9 to always be pressed against the support 18 under all conceivable temperature conditions including the length expansions of the capacitor 9, the support 18 and the tensioning belt 19 which are dependent on said temperature conditions.

However, since high temperature fluctuations inevitably occur in the electric machine 7, in particular when this is operated highly dynamically, the capacitor 9 would be subject to considerable temperature changes with the associated thermal expansions which are noticeable particularly in the direction of greatest expansion of said capacitor, that is to say in the direction of the circumference. In order to permit good thermal connection while at the same time compensating for manufacturing tolerances and thermal expansions, a layer (not illustrated here) which is composed of a permanently elastic material which is as highly thermally conductive as possible, for example a so-called silpad, can be provided between the capacitor 9 and the cooled surface of the support. As a result, the thermal cycle stability is likewise increased.

As an alternative to the embodiments selected here, the capacitor 9 can of course also be cooled on its outer circumference. However, the information given here analogously applies in that case too.

When capacitors 9 of this type are, as is typical, designed as foil capacitors, as is schematically illustrated in cross section in FIG. 5, the capacitor 9 may comprise a plurality of correspondingly metallized foil layers 20 which are wound one above the other directly on the support 18 in a slightly offset manner. Each of the side edges of the capacitor 9 is then provided with a layer, the so-called spray-metallized layer 21, which in each case electrically and mechanically connects half of the films to one another. This spray-metallized layer 21 may, for example, be composed of metal which is sprayed on in the liquid state and then hardened. The spray-metallized layer 21 is also used to make electrical contact with the capacitor 9, with one spray-metallized layer 21 being connected to the positive terminal of the power source 17 and the other being connected to the negative terminal of said power source.

If an alternating thermal load now occurs with the corresponding varying expansions of the capacitor 9, the relatively elastic foils 20 will suffer no damage. However, (micro)cracks or hairline cracks are produced in the spray-metallized layers 21, which are far less elastic, on account of the varying thermal expansion. In order to avoid this, one refinement of the invention provides for the spray-metallized layers 21 to be provided with a plurality of complete or continuous separations 22 distributed around the circumference.

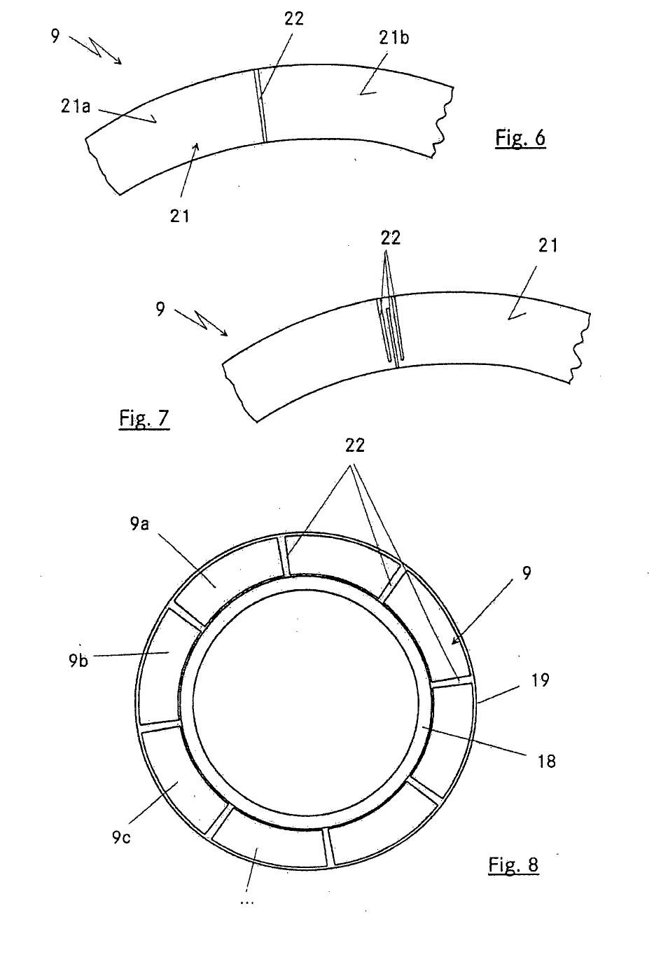

FIG. 6 shows an example of such a continuous radial interruption 22. This interruption 22, which functions as an expansion joint, allows the capacitor 9 to react to alternating thermal stresses in an appropriate manner, without said capacitor or its spray-metallized layer 21 being destroyed. The continuous interruption 22 of the embodiment according to FIG. 6 divides the spray-metallized layer 21 of the capacitor 9 into a plurality of individual regions 21a, 21b, . . . of the spray-metallized layer 21. However, since said spray-metallized layer simultaneously forms the electrical contact-making area of the capacitor 9, the individual regions 21a, 21b, . . . have to be connected to one another by means of an electrically conductive busbar arrangement 23 with length-compensation elements 24, which busbar arrangement is not illustrated here but will be explained in even greater detail below.

An alternative refinement to this arrangement is schematically indicated in FIG. 7. The interruptions 22 shown there are merely in the form of partial interruptions 22, with the result that part of the spray-metallized layer 21 is retained in the radial direction in each case. If, as indicated in FIG. 7, in each case at least three of the partial interruptions 22 are now correspondingly grouped, the spray-metallized layer 21 assumes a meandering configuration in this region. As a result, the cyclical expansions due to the alternating thermal loads can be compensated for without the spray-metallized layer 21 having to be completely interrupted.

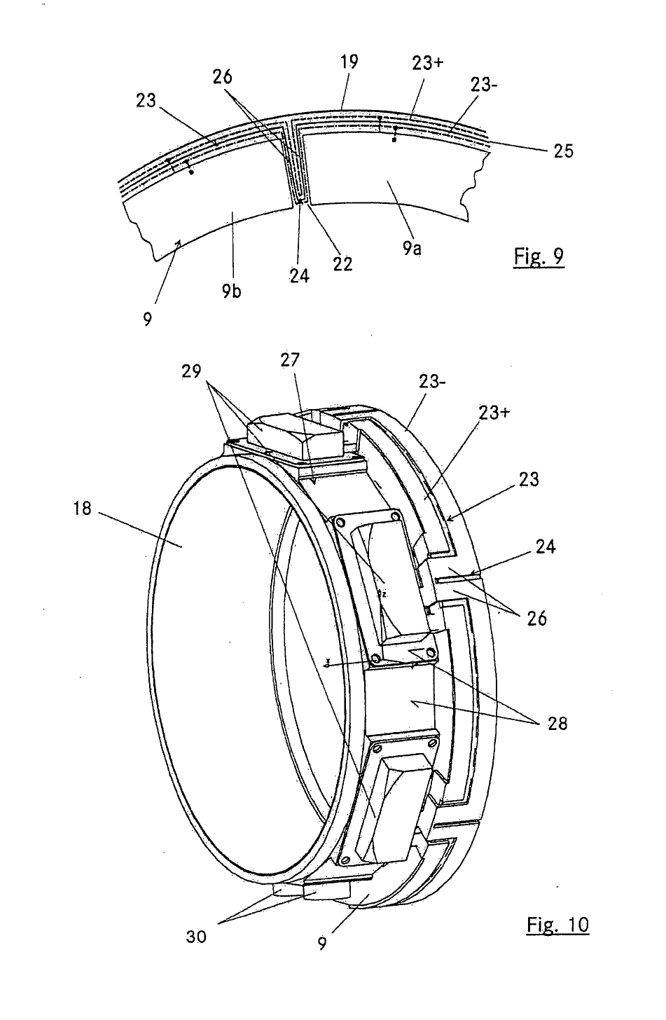

FIG. 8 illustrates a further alternative refinement of the interruptions 22. In contrast to the previous embodiments, in which only the spray-metallized layers 21 have been provided with interruptions 22, the entire capacitor 9 is broken up into sub-elements 9a, 9b, . . . here. The individual sub-elements 9a, 9b, . . . , which can be produced, for example, by splitting up a capacitor 9 which is wound in the form of a ring, are fitted to the support 18 in an analogous manner to that already described and clamped to said support by means of the tensioning belt 19. The tensioning belt 19 and the abovementioned electrically conductive busbar arrangement 23, which is of course also necessary here, are shown in greater detail in FIG. 9. In this case, the tensioning belt 19 comprises the busbar arrangement 23, which has a respective individual bar 23+, 23− for each electrical terminal, as the outermost layer. In this case, the individual bars 23+, 23− are each connected to one of the spray-metallized layers 21 of the sub-elements 9a, 9b, . . . of the capacitor 9. If the individual bars 23+, 23− are positioned one above the other, as is the case here, an electrical insulation structure 25 is to be provided between them. The tensioning belt 19 is preferably formed from an electrically conductive material. However, this material then has to be electrically insulated from at least one terminal of the capacitor 9. It has been found in this case that a design of this type with an electrically conductive tensioning belt 19 has a positive effect on the inductive behavior and the EMC of the electric machine 7 and its power electronics.

Length-compensation elements 24 are also provided in order to compensate for the thermally-induced changes in length in the busbar arrangement 23. In the embodiment of said busbar arrangement illustrated here, said length-compensation elements protrude into the interruptions 22 between the sub-elements 9a, 9b, . . . of the capacitor 9. The length-compensation elements 24 therefore have sections 26 which extend substantially in the radial direction of the electric machine 7. On their side which faces away from the main surface of the busbar arrangement 23, the sections 26 ensure the electrical connection between the individual regions of the busbar arrangement 23 in a manner radially offset with respect to the busbar arrangement 23. If thermally induced expansions which typically manifest themselves mainly in the circumferential direction of the busbar arrangement 23 are produced, they are absorbed by elastic deformation of the length-compensation elements 24. The length-compensation elements 24 can compensate for the tolerances and thermal expansion in the interruptions 22 between the sub-elements 9a, 9b, . . . of the capacitor 9 in the radial direction.

By arranging the length-compensation elements 24 in the interruptions 22 between the sub-elements 9a, 9b, . . . of the capacitor 9 or, in alternative refinements of the busbar arrangement 23, in the region of the interruptions 22 in the spray-metallized layer 21, the length-compensation elements 24 and the interruptions 22 which act as expansion joints are coordinated such that reliable operation of the capacitor 9 is possible over the long term. This arrangement also saves on space and the busbar arrangement 23 can even out the forces acting on the capacitor 9 or its sub-elements 9a, 9b, . . . .

However, the high level of integration of capacitor 9 and in particular of power electronics means any repairs which may be necessary are difficult and special components are required in each case for slightly different embodiments of the electric machine 7. Therefore, it is hardly ever possible to use identical components across a range of different embodiments, which, however, would lead to a reduction in costs. Furthermore, in the case of the configuration of the arrangement of the semiconductor components of the power electronics (switches 10, diodes 11) together with the associated GDUs 14, it is necessary to take new paths in order to make optimum use of the installation space available.

Therefore, the power electronics are also arranged on the outside of the support 18 in the radial direction and next to the capacitor 9, for example offset in the axial direction of the electric machine 7, as can be seen in FIG. 10. In this region, the support 18 is in the form of a polygon 27 which preferably has a plurality of flat surfaces 28. At least some of these surfaces 28 of the polygon 27 are equipped with power-electronics modules 29, it not being necessary for all surfaces 28 to be occupied. On account of the flat design of the surfaces 28, the components of the power electronics (switches 10, diodes 11) engage the flat surfaces over their full extension and are therefore very effectively cooled by the cooling system in the support 18.

The power-electronics modules 29 may, for example, include
a bridge leg 12, possibly including the GDU 14;
three lower-power bridge legs 12;
a current sensor which may possibly be cooled by means of the surface 28 of the polygon 27;
inductive components, for example inductors;
electrical filter components, for example Y capacitors or current-compensated inductors;
cooled connection points, for example terminals for the AC or DC connections;
printed circuit boards with open-loop and closed-loop electronics or sensor systems;
printed circuit board with bus couplers, for example for communication via a CAN bus;
DC voltage converters, so-called DC/DC converters, for feeding the 12V on-board electrical system of the power-electronics controller or for redundantly feeding safety-relevant loads;
connection elements 30 for cooling in the support 18.

It is now possible to realize different embodiments quickly and simply in a modular manner on account of the different variants of the surfaces 28 of the polygonal region 27 being equipped with different power-electronics modules 29.

For example, the surfaces can be equipped with a minimum number of power-electronics modules 29, for example three for a low-power electric machine 7, as has been explained in the form of a circuit diagram in FIG. 2. The remaining areas 28 of the polygon 27 can then be used to carry other electronics modules which are not directly required for operating the electric machine 7, or they can remain empty.

As an alternative to this, said surfaces can also be equipped with twice the number of power-electronics modules 29, that is to say six items, for a higher-power electric machine 7. In this case, the power-electronics modules 29 are then either connected in parallel or each bridge leg 12 is connected to one end of one of the motor windings 13, as a result of which so-called “open windings” are produced.

In all cases, it is possible to equip the surfaces with additional low-power (power-) electronics modules 29:
in order, for example, to integrate a further inverter which can be used, for example, for an oil pump or for feeding external loads via a kind of socket; and/or
in order to raise the battery voltage with modules 29 which correspondingly change the topology to a higher, possibly controlled level (step-up actuator) from which the actual power-electronics modules 29 for the electric machine 7 are then fed.

In this case too, the support 18, through which a cooling medium flows and which cools the stator S as well as the power electronics and the capacitor 9, extends around the stator S. The connections 30 are provided to supply and discharge the cooling medium.

The support 18 has an annular region and a polygonal region 27, these regions being arranged next to one another in the axial direction of the electric machine 7. The capacitor 9 and the power-electronics are situated on these regions such that they are distributed around the circumference in the radial direction in the form of the above-described (power-) electronics modules 29. The capacitor 9 which can be seen on the right of the illustration in FIG. 10 has a few radial interruptions 22 in its spray-metallized layer 21, which interruptions are distributed around its circumference but cannot be seen in FIG. 14. Two parts 23+, 23−, which run next to one another, of the electrical busbar arrangement 23 make contact with the sub-elements 9a, 9b, . . . of the capacitor 9. In this case, the sections 26 of the length-compensation elements 24 of the busbar arrangement 23 extend in the axial direction with respect to the electric machine 7. Said length-compensation elements can at the same time be in electrical contact with the (power-) electronics modules 29 in the region in which they approach said (power) electronics modules 29. The length of the connection lines is therefore reduced further still.

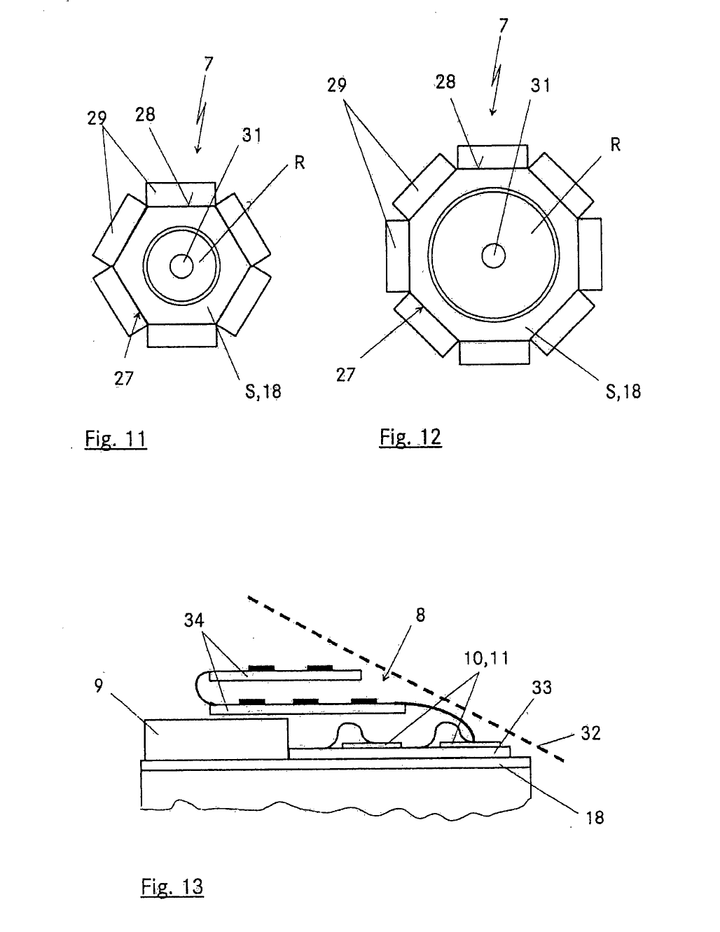

FIG. 11 and FIG. 12 are cross-sectional views of a schematically illustrated electric machine 7. In addition to a rotor R with the shaft 31, the assembly comprising the stator S and the cooled support 18 is illustrated as one part here. As can be seen from the illustrations, it is very easy to adapt the arrangement to the diameter and therefore typically to the power of the electric machine 7. This is made possible by means of polygons 27 with different diameters and a different number of surfaces 28. Therefore, a polygon 27 with six surfaces 28 can, for example, be used for an electric machine 7 with a small diameter, and a polygon 27 with eight or twelve surfaces 28 can be used for an electric machine 7 with a large diameter. Of course, polygons 27 with other numbers of surfaces are also possible. Given ideal cooling on account of the flat bearing surfaces, (power-) electronics modules 29 which are identical and therefore can be produced at lower cost in large numbers are used for different physical shapes and sizes of electric machines 7 as a result of the modular design of the power electronics.

In this case, the polygon 27 may be designed as a holder for the (power-) electronics modules 29 such that it is separate from the stator and/or the support 18 for the capacitor. However, as an alternative to this, the outer contour of the stator may already be in the form of a polygon 27 or a polygonal support 18 with additional cooling ducts. This does not affect the possibility of the stator being segmented. If the polygon 27 can be separated from the stator, it may be equipped with the power electronics before the stator is mounted. The entire power electronics can therefore be checked before the stator is mounted.

As has already been mentioned a number of times, the support 18 is cooled. In this case, it can either have continuous cooling ducts, or the surfaces 28 of the polygon 27 can surround the cooling ducts. If individual surfaces 28 of the polygon 27 remain unused in an assembly of this type, dummy elements are then naturally required for closing the unused openings in the cooling circuit of the support 18.

If the surfaces 28 are now formed as one component together with the (power-) electronics modules 29, it is very easy to influence subsequent cooling of said (power-) electronics modules 29 with the configuration of the (power-) electronics modules 29. Therefore, surfaces 28 with a high cooling requirement can be cooled more directly and more intensively by structures for reducing the thermal contact resistance, for example in the form of cooling ribs etc., being arranged on that side of the surface 28 to be cooled which faces the cooling means. In contrast, surfaces 28 with a lower requirement for intensive cooling will not exhibit such structures. Typically, the more intensively cooled surfaces 28 are usually used for power-electronics components with a high power density loss. The less intensively cooled surfaces 28 can be used for indirectly cooling the components with a lower power density loss, for example sensor system, actuating means for the power electronics etc. It is easily possible to adapt the structures on the side which faces the cooling means in accordance with the expected power density loss. Therefore, it is possible to save on structures at points with a low cooling power requirement, and this has advantages in terms of production and reduces the flow resistance when coolant flows through.

In order to further increase the ability to use identical parts when selecting the (power-) electronics modules 29, the polygon 27 may also have surfaces 28 of different length, as can be seen in FIG. 10. With the different angular pitch of the polygon 27, for example 6 sections extending over in each case 40° and 6 sections extending over, in each case, 20°, may be provided so as to form at least some surfaces 28 which provide sufficient space, for example, for bridge legs 12, even in the case of relatively small electric machines 7.

Because of the restricted space conditions during integration of the electric machine 7 into the converter bell 4, utilization of the available pre-specified installation space has to be achieved in as ideal a manner as possible. One way of utilizing the installation space is illustrated in FIG. 13. Beneath the curved installation space limit 32 through the converter bell 4 (not illustrated here), the flat part of the power electronics, that is to say the ceramic substrate 33 with the bonded chips (switches 10 and diodes 11), is positioned as far as possible beneath the slope curved area, and the associated electronics for actuation purposes and also the GDU 14 are adapted to the stator 32 in one or more layers 34 which are shortened and/or offset axially to the electric machine 7 and situated above the latter. In this case, the layers 34 can also come to rest partially above the capacitor 9. This may lead to the length of the actuating lines being increased on account of the substrate and actuating electronics lacking a cover, but saves space.

However, overall, the length of the connection lines is kept short in the structures illustrated here because of the very compact integration arrangement and the capacitor 9 and (power-) electronics modules 29 being immediate neighbors. The occurrence of inductively induced voltage peaks can therefore be reduced to an absolute minimum.

What is claimed is:

1. A drive train for a motor vehicle including an internal combustion engine (2) and a transmission (3) with a converter bell (4) being arranged between the internal combustion engine (2) and the transmission (3), a drive shaft (5) extending through the converter bell (4), a clutch device (6) and an electric machine (7) disposed on the drive shaft (5), and a stator (S) including a cooling system disposed in the converter bell (4) together with a power converter, which comprises at least one capacitor (9) and power electronics, being integrated in the converter bell (4), said capacitor (9) and said power electronics being arranged between the stator (S) of the electric machine (7) and the converter bell (4) such that they are distributed radially around the outer circumference of the electric machine (7), with the capacitor (9) and the power electronics being arranged such that they are in thermally conductive contact with the cooling system of the stator (S) of the electric machine.

2. The drive train as claimed in claim 1, wherein the capacitor (9) and the power electronics together with electronic controls for actuating the power electronics are disposed one above the other in at least two layers (34), with the layers (34) having different dimensions and being offset in relation to one another in the axial direction of the electric machine (7).

3. The drive train as claimed in claim 1, wherein the stator (S) and the cooling system of the stator (S) have a polygonal region (27) with flat surface areas (28) which is situated next to the annular region thereof in the axial direction of the electric machine (7), with the power electronics being arranged at least on some of the flat surface areas (28) of the polygonal region (27).

4. The drive train as claimed in claim 3, wherein the polygonal region (27) has flat surface areas (28) with different edge lengths.

5. An electric machine for a motor vehicle for integration into a drive train including an internal combustion engine (2) and a transmission (3) with a converter bell (4) being arranged between the internal combustion engine (2) and the transmission (3), a drive shaft (5) extending through said converter bell (4), a clutch device (6) and an electric machine (7) disposed on the drive shaft (5), and a stator (S) disposed in the converter bell (4) together with a power converter (8) and control electronics for the power converter (8) and a capacitor (9) extending around the outer circumference of the electric machine (7) and having a plurality of at least partial separations (22) distributed over the circumference of the capacitor (9).

6. The electric machine as claimed in claim 5, wherein the capacitor (9) and the power electronics are in thermally conductive contact with a cooling system of the stator (S) of the electric machine (7).

7. The electric machine as claimed in claim 5, wherein the capacitor (9) is broken up into a plurality of sub-sections (9a, 9b, . . . ), with an electrically conductive busbar arrangement (23) being disposed in contact with the sub-sections (9a, 9b, . . . ).

8. The electric machine as claimed in claim 7, wherein spray-metallized layers (21) of the capacitor (9) are formed on axial side surfaces of said capacitor and are provided in each case with several full separations (22) which extend in the radial direction and are distributed around the circumference, with an electrically conductive busbar arrangement (23) making contact with the individual sections (21a, 21b, . . . ) of the spray-metallized layers (21).

9. The electric machine as claimed in claim 5, wherein spray-metallized layers (21) of the capacitor (9) are formed on the axial side surfaces of the capacitor and are provided with partial separation regions (22) which are distributed around the circumference, with, in each case, at least three of the partial separations (22) being grouped such that the spray-metallized layers (21) assume a meandering configuration in these regions.

10. The electric machine as claimed in claim 8, wherein the busbar arrangement (23) has length-compensation elements (24) with sections (26) which extend substantially in the axial direction of the electric machine (7) to provide for circumferential resiliency ensuring electrical connection of the individual sections of the busbar arrangement (23).

11. The electric machine as claimed in claim 8, wherein the busbar arrangement (23) has length-compensation elements (24) with sections (26) which extend substantially in the radial direction of the electric machine (7) and ensure electrical connection of the individual sections of the busbar arrangement (23).

12. The electric machine as claimed in claim 11, wherein the length-compensation elements (24) extend into the regions between the sub-elements (9a, 9b, . . . ) of the capacitor (9).

13. The electric machine as claimed in claim 9, wherein the length-compensation elements (24) of the busbar arrangement (23) are arranged in the same regions of the capacitor (9) in which its at least partial separations (22) are disposed.

14. The electric machine as claimed in claim 13, wherein the electrical contact between the busbar arrangement (23) and the power electronics is arranged in the region of the length-compensation elements (24).

15. The electric machine as claimed in claim 14, wherein the capacitor (9) is held in engagement with the stator (S) under pre-stress by a tensioning belt (19) surrounding the capacitor arrangement.

16. The electric machine as claimed in claim 15, wherein the tensioning belt (19) is formed from an electrically conductive material, with said tensioning belt being electrically insulated at least from one terminal of the capacitor (9).

17. The electric machine as claimed in claim 5, wherein at least one of the stator (S) and the cooling system of the stator (S) comprises a polygonal structure (27) which is situated next to the capacitor (9) in the axial direction of the electric machine (7) and forms flat surface areas (28), with power electronics being arranged at least on some of the flat surface areas (28) of the polygonal structure (27).

18. The electric machine as claimed in claim 17, wherein the flat surface areas (28) of the polygonal structure (27) have different edge lengths.

19. The electric machine as claimed in claim 17, wherein the number of flat surface areas (28) of the polygonal structure (27) is increased with an increased diameter of electric machine (7).

20. The electric machine as claimed in claim 18, wherein the power electronics are disposed on the surfaces (28) of the polygonal structure (27) which face away from the power electronics and which is in contact with a cooling liquid.

21. The electric machine as claimed in claim 20, wherein at least some of the surfaces (28) which are in contact with the cooling liquid have cooling ribs for improving heat transfer between the surface (28) and a cooling liquid, with the configuration and presence of the cooling ribs being determined as a function of the power loss generated by the power electronics which are arranged on the respective surface (28).

22. The electric machine as claimed in claim 6, wherein the capacitor structure (9) is wound directly onto one of the stator (S) and the cooling system of the stator (S).
